(19) United States
(12) Patent Application Publication
(10) Pub. No.: US 2011/0127223 A1
(43) Pub. Date: Jun. 2, 2011

(54) PROCESS FOR TREATING POND WATER

(75) Inventors: Vaughn V. Astley, Lakeland, FL (US); Dennis H. Michalski, Lakeland, FL (US); Robert Cook, Montgomery, TX (US)

(73) Assignee: VEOLIA WATER NORTH AMERICA OPERATING SERVICES, LLC, INDIANAPOLIS, IN (US)

(21) Appl. No.: 12/953,633

(22) Filed: Nov. 24, 2010

Related U.S. Application Data
(60) Provisional application No. 61/265,935, filed on Dec. 2, 2009.

(51) Int. Cl. C02F 1/58; C02F 1/52; C02F 1/66; C02F 9/04; C01B 25/32; C01B 25/45

(52) U.S. Cl. 210/712; 210/724; 423/307; 423/306

(57) ABSTRACT

A process for the treatment of phosphoric acid plant pond water where an increased recovery of phosphorus values from the input pond water is achieved through the dilution of the initial pond water with clarified water from the product generation stage and/or the final stage clarified water. The recycle of the product generation stage and/or final stage waters to dilute the feed pond water mitigates or eliminates the problems of silica gel formation and precipitation that occur when undiluted pond waters are processed. In addition, the dilution reduces phosphate losses in the first liming or neutralization stage rejected solids thereby increasing the yield of Di-Calcium Phosphate or ammonium magnesium phosphate or potassium magnesium phosphates.

### CROSS REFERENCE TO RELATED APPLICATIONS

The present application claims priority to U.S. Provisional Patent Application No. 61/265,935 filed on Dec. 2, 2009. The entire disclosure content of this application is herewith incorporated by reference into the present application.

### FIELD OF INVENTION

This invention relates to a method of treating pond water resulting from the operation of wet process phosphoric acid plants. More specifically, this invention relates to a process for treating pond water that, compared to conventional methods currently practice (such as the double-liming process), decreases lime usage, recovers a higher fraction of water for discharge and/or reuse, and decreases sludge impoundment area requirements while recovering phosphate as a valuable product.

### BACKGROUND

Production of phosphoric acid by the so-called “wet process” involves the reaction of finely ground phosphate rock with sulfuric acid. As a result of the various reactions, a slurry is produced containing phosphoric acid, calcium sulfate and various impurities derived from the phosphate rock. This slurry is normally filtered to separate the phosphoric acid product from the byproduct calcium sulfate. The phosphoric acid thus obtained is then used in the production of various phosphate products such as ammonia-based fertilizers.

Several variations of the wet process for phosphoric acid manufacture are utilized around the world, but the most commonly employed is the Di-Hydrate process in which a specific crystalline form of calcium sulfate is produced by reaction of the calcium present in the raw phosphate ore, and the sulfuric acid used to acidulate the ore. Approximately five tons of calcium sulfate or gypsum are formed per ton of phosphate (P₂O₅) produced. Water is normally used to wash the calcium sulfate filter cake and thereby increase the recovery of the phosphoric acid product. Most of this wash water is fed back into the phosphoric acid production process as make-up water. However, a portion of this water together with some residual phosphoric acid remains trapped in the calcium sulfate filter cake and is thus discharged with the filter cake. This trapped water contains several percent of phosphoric acid and lower amounts of other impurities that are also present in the raw material used to produce the phosphoric acid product. Additional water is normally used to help discharge the calcium sulfate filter cake off of the filter and then large volumes are used to transport it, by pumping a slurry to a storage or disposal area. Thus, the discharge, or “pond water” as it is generally referred to, is created. The pond water generated in the process is of substantial volume and its storage and disposal are significant factors in the operation of a phosphoric acid plant. Measures to effectively treat and recover the impurities and valuable byproducts respectively lost in the pond water are of great economic and environmental importance to the plant as well as regulatory agencies and the general public.

At the storage or disposal area, the calcium sulfate will settle and the excess transportation water will be liberated. This liberated water will normally be collected in a system of channels and ponds and recycled to the phosphoric acid production plant for reuse. The pond water is used to wash the calcium sulfate filter cake, cool and scrub process vapors, as an aid in grinding the rock to produce a slurry, and other purposes that do not require fresh water. These channels and ponds also serve as a collection site for other water that is used in and around the phosphoric acid plant, such as for cleaning or washing, fresh water fume scrubbers, and as a collection site for phosphoric acid spills or leaks within the plant. Also, since these channels and ponds are located outside, they collect rainwater.

Since all of the water contained within these channels and ponds contains small amounts of phosphoric acid and other impurities normally present in the phosphoric acid, it is considered contaminated. For example, the recycled or process water contains about 0.25-3% phosphoric acid, similar amounts of fluoride species, 100's to 1,000's milligrams per liter of ammonia, and trace amounts of many heavy metals. As such, it is a very acidic and concentrated salt solution. The phosphoric acid industry alternately refers to the plant pond water as pond water, cooling pond water, gyp stack water, gypsum pond water, and wastewater. Pond water has many sources in a phosphate complex, including the barometric condenser water, scrubber water, and gypsum stack water. These streams report to a large open containment area referred to as the pond. A pond can cover large areas and contain billions of gallons of pond water. The accumulated water must be treated or purified to remove phosphoric acid and other impurities prior to being released to the environment. In cases where the phosphoric acid plant is operated very efficiently and in the absence of severe weather conditions, a balance will exist between the water input to the pond system and water evaporated from it such that virtually all of the pond water can be recycled and reused in the plant. In these rare cases, treatment and discharge of the pond water is not necessary.

There exist a number of circumstances where treatment and discharge of pond water is necessary, such as an extended period of abnormally heavy rainfall. When rainfall is not balanced by evaporation, such as in the case of significant storm events or a drought, the process water balance is commensurately impacted. Of greatest consequence are cases where excessive water accumulation causes water inventories to rise to unsafe levels, risking containment breaches. Environmental damage can occur if the pond water is abruptly discharged into local streams and rivers. Thus, it is necessary to routinely reduce excessive contaminated pond water inventories to prevent unintended discharge.

Another scenario where it is necessary to address pond water inventory disposal is when the phosphoric acid plant has idled operation for an extended period of time, or permanently.

Many factors influence the specific components and their concentrations in pond water. The major chemical components along with the typical range of concentration that can be found in most pond waters is as follows:

| Component | Typical Concentration Range | |
|---|---|---|
| P | 1000-12,000 | ppm |
| SO₄ | 4300-9600 | ppm |
| F | 50-15,000 | ppm |
| Si | 30-4100 | ppm |
| (ammoniacal) N | 40-1500 | ppm |
| Na | 1200-2500 | ppm |
| Mg | 160-510 | ppm |
| Ca | 450-3500 | ppm |
| K | 80-370 | ppm |
| Fe | 5-350 | ppm |
| Al | 10-430 | ppm |
| Cl | 10-300 | ppm |

Normally the major acidic components of pond water are phosphoric acid (H₃PO₄) and sulfuric acid (H₂SO₄), with lesser amounts of hydrofluorosilicic acid (H₂SiF₆), and hydrofluoric acid (HF). The pond water is normally saturated or supersaturated with respect to many of its constituent ions, except when it becomes diluted due to heavy rainfall, etc. Also, since the pond water is located in outdoor ponds and can also be used for cooling, it is continuously subjected to thermal cycling which can further affect the solubility of ions dissolved in solution.

The process of treating pond water in two stages of neutralization with common lime and/or limestone reagents (so-called “double liming”) has been the industry standard for treating pond water. A general schematic of the process as is known in the art is shown in FIG. 1. This method consists of adding a lime-based calcium compound such as CaCO₃, Ca(OH)₂ and/or CaO to the pond water in two stages such that the fluoride, phosphate and other impurities form solid precipitates that settle and are separated from the thus purified water. This method is described in Francis T. Nielsson, ed., Manual of Fertilizer Processing, Marcel Dekker, Inc. (1987), pp. 480 to 482; G. A. Mooney, et al., Removal of Fluoride and Phosphorus from Phosphoric Acid Wastes with Two Stage Line Treatment, Proceedings of the 33rd Industrial Waste Conference, Purdue Univ. (1978); G. A. Mooney et al., Laboratory and Pilot Treatment of Phosphoric Acid Wastewaters, presented at the Joint Meeting of Central Florida and Peninsular, Florida A. I. Ch. E. (1977); and U.S. Pat. Nos. 5,112,499; 4,698,163; 4,320,012; 4,171,342; 3,725,265 and 3,551,332. Other processes have been processed to treat pond water and other waste streams, including those described in U.S. Pat. Nos. 7,560,031; 6,241,796; 7,491,333; 6,758,977; and 6,758,976.

FIG. 2 is a more detailed illustration of the double liming. In the first stage neutralization 20a, lime and/or limestone 12 is added to pond water 10 to raise the pH of the solution to about 4-5, resulting in the precipitation of fluoride as CaF₂ and/or CaSiF₆. It is also thought that some of the hydrofluorosilicic acid present dissociates to HF and SiF₄, with the SiF₄ hydrolyzing to HF and SiO₂. Some phosphate is also precipitated at this stage, as well as some calcium sulfate. The limed water, stream B, is then clarified in 20b, being separated into a clarified overflow stream, stream D, and an underflow, stream E, containing the precipitated solids. The sludge produced at this stage is a granular, crystalline material that settles fairly rapidly and can be de-watered to about 30% solids in a gravity thickener. The sludge, stream E, can be sent to disposal 30 at the plant gypsum stack or recycled to the phosphoric acid plant for recovery of the phosphate.

In the final neutralization stage 60a, additional lime, is added to the clarified liquid from the first separation stage 20b, stream D, to pH 8-10. In stage 60a, most of the remaining phosphate and fluoride are precipitated along with sulfate and many of the metals. The sludge in this stage has poor settling and thickening properties due to the nature of the compound phases formed, and rarely achieves more than 5-7% solids by weight. The sludge, stream H, from this final separation stage 60b is normally deposited 30b in large lagoons to allow for additional de-watering. In some double liming applications, some of the final neutralization stage underflow, stream H, is sent back to the pond water reservoir 10 or added to the first stage 20a. However, without sufficient agitation, the bulk of the lime, coated with the reacted solids formed in the final stage 60a, sits at the bottom of the pond. If too high, a proportion is added to the first stage, the system may become disrupted, due to the poor settling characteristics of these solids. For these reasons, most of the conventional double liming final stage underflow solids are impounded in their own pond, 30 and the phosphate values thus are lost. In still other cases, some solids from the first stage separation underflow solids Stream E are blended with the final stage underflow, stream H in an effort to serve as a ballast and mitigate the settling problems associated with the solids in the final stage 60b. However, this can have unintended consequences on the effluent quality from the process.

If the final separation stage 60b clarified water, stream G, contains unacceptable levels of soluble ammonia, the final neutralization stage system 60a can be operated at a higher pH, from pH 10-12, to de-ionize the ammonia and raise its volatility. The increased volatility facilitates its removal via air stripping 80 using spray devices located in or floating on the sedimentation lagoon. Even without the addition of a spray system 80, operation of the treatment lagoon at a pH of 9-10+ results in the removal of ammonia through volatilization due to the large surface area available for such activity.

The water stream I is then pH-adjusted with acid to produce a final discharge effluent from the process 90. The fraction of final effluent obtained from a double liming process is about 50-70% of the feed volume (stream 10).

As an alternative to the double-liming process, liming can be carried out in a single stage. However, there are several problems associated with this method. One problem is the large volume of sludge produced. Sludge (the mixture of precipitated solids, un-reacted calcium compounds and water) produced in a single state would be very voluminous and de-water slowly, and thus would require larger settling ponds compared to a double-liming process. Another significant problem with this treatment process is that very large volumes of lime are required to neutralize the acidic pond waters, owing to the stoichiometry differences between a single and double-liming process. This can also affect the quality of the effluent because, for example, fluoride removal to levels typically regulated (i.e., <20 mg/L F) in a single-stage liming system.

Another problem common to the double-liming process is the propensity of a silica gel to form, particularly when the fluoride and silica concentrations are relatively high. This can cause significant problems to the operation of the process, such as the generation of thick, difficult to settle and/or separate process streams and sludge. Silica gel can also cause problems with the operation of process equipment and instrumentation. Thus, the avoidance and mitigation of silica gel formation can significantly enhance the robustness and efficiency of pond water treatment facilities. In addition, the formation and handling of the second stage sludge is further exacerbated owing to the inherently voluminous nature of the phosphate phase typically formed (hydroxy-apatite) because co-precipitation of silica with this material leads to a further increase in the cost of managing, storing and eventual impoundment.

It would be highly desirable to have a process that utilizes less lime in the treatment of the pond water to reduce the cost of treating it. It would also be highly beneficial to reclaim un-reacted, excess lime for reuse in the neutralization stages, thus limiting lime input. Furthermore, it would be highly desirable to have a method of reclaiming the phosphate in the pond water to enhance the overall phosphate production yield from the plant as this would simultaneously reduce the acidity and toxicity of the pond water, better enabling its discharge to the environment. This invention serves these important needs (and others) as will become apparent.

The main operational criteria used for the generation of an animal nutrient (feed-grade) Di-Calcium phosphate product can be routinely determined the liquid phase phosphorus and fluoride concentrations before and after the Di-Calcium Phosphate product generation stage, as these are key constituents that must meet accepted US (and other) standards for use. The waters and phosphate products contain the phosphate moiety, PO₄, and this phosphate content can be analytically expressed as PO4, P2O5 or P. Despite successes in meeting the compositional criteria, however, many attempts to separate and recover such a product have been practically thwarted by the co-precipitation of silica (or the formation of a polymerized silica gel). The silica renders separation difficult (and in most cases, impossible) and also acts to dilute the product phosphate concentration so that it no longer meets accepted specifications for use as an animal feed-grade product.

The difference in the phosphorus concentrations of the clarified water from the first neutralization stage and the resultant water from the product generation stage (e.g., P1−P2), divided by the difference in the fluoride concentrations of the clarified water from the first liming or neutralization stage and the resultant water from the product generation stage (e.g., F1−F2) must be (P1−P2)/(F1−F2)≧100 in order to achieve a feed grade product. The pH set points in the first stage and the product generation stage are thus set to accomplish the above criteria. This results in a feed-grade Di-Calcium phosphate product, and maximizes the recovery of phosphorus values from the pond water as a valuable resource.

### SUMMARY

The process improvements that are an object of this disclosure are applicable to all processes where phosphate pond water is treated by liming.

It is an object of the embodiments enumerated below to provide improvements to the known processes for the purification of pond water such that a significantly enhanced yield of a salable phosphate product is generated, and that the resultant water has a reduced propensity to precipitate silica. In addition, the formation and separation of Di-Calcium Phosphate, struvite (ammonium magnesium phosphate (NH₄)MgPO₄.6H₂O), and/or potassium magnesium phosphate can be carried out unaffected by the typical silica gels that usually form in high fluoride and silica containing pond waters. The recycle of a portion of the final stage slurry or sludge further enhances the recovery of phosphate values, provided the concentration of phosphate is limited to minimize that lost in the first stage.

The present invention provides a process for the treatment of pond water while facilitating the recovery of phosphate values. The process enables the recovery of phosphate values typically lost in treating pond water by the traditional double liming process. The phosphate product recovered by the process has a significant market value compared to the voluminous waste (of no value) generated by the double liming process. These benefits are made possible through the dilution of the initial pond water with product generation stage or final stage clarified water.

The concentration of phosphorus in many raw pond waters (typically pH 1-2) has been found to be >5,000 parts per million (ppm) as P, with waters some containing near 10,000 ppm as P. However, the concentration of phosphorus is a strong function of pH and at pH 4 is typically ≦4,000 ppm. Thus, a significant loss of phosphorus values can occur during the first stage neutralization. We have found that by recycling clarified water defined as final stage clarified water, or the re-clarified water after the product generation stage, or clarified water from any later stage, and including mixtures thereof whose phosphorus values are generally around 10 and 1,000 ppm, respectively, the loss of P in the first stage is minimized because the added recycle volume carries more dissolved P out of the first stage. This is possible because, as noted above, the P concentration is function of pH so the added volume afforded by recycle contains more mass of P even though the P concentration may be unchanged at a given pH set point; consequently the reduced loss (or yield gain) using this approach.

As an example, consider a scenario where a 1 L/min of pond water containing 8,000 ppm P is treated in a first stage to pH 4, resulting in first stage clarified effluent containing 4,000 ppm P (mass of P leaving first stage is about 1 L/min×4,000 ppm=4000 mg/min). This represents a net loss of 50% of the phosphorus values from the initial pond water. However, when the initial pond water is diluted with a volume of final stage clarified water containing zero P at 0.5 L/min (i.e. a 0.5:1 dilution), this results in 1.5 L/min of treated water, but at the same concentration of approximately 4,000 ppm P (at the same set-point pH of 4, the P concentration remains the same because P concentration is a function of pH). Thus, the net mass of P leaving the first stage is 1.5 L/min×4,000 ppm=6,000 mg/min. This is a 50% improvement over a non-dilute operation and a net (6000−4000)/8000=25% increase in P recovery.

It can be shown that the net gain in P recovery continues to increase with additional dilution, and is generally only practically limited by process design considerations. On the precipitation of the P from this first stage water, by raising the pH to around 6.5 to 7.5 (as is accomplished to recover the P as a Di-Cal product), the residual P content is typically around 1,000 ppm. Thus a comparison of the product yields from the example given above would be 4,000 mg−1,000 mg=3,000 mg without dilution, and 6,000 mg−1,000 mg=5,000 mg at a 0.5 dilution ratio, for a net (5,000−3,000)/3,000×100%=66.7% increase in P yield. It is clear from this example that further increases in the dilution ratio result in commensurate increases in P yield.

Further to the P yield increases achieved with dilution, the recycle of the product generation stage and/or final stage waters, when used to dilute the initial pond water, greatly mitigates and in some cases eliminates the problems associated with silica gel formation and precipitation, as much of the silica has already been precipitated from these two water streams. Since silica gel and precipitation is a function of concentration, ionic strength, (and other variables), the effects of dilutions are to make it more stable so that it does not gel or precipitate compared to undiluted pond water treatment. This is a very significant improvement, as the silica aging step of the prior known process is not needed, the product is readily separable, and it is much purer compared to the product obtained from undiluted pond water treatment. The formation of silica gels and/or precipitates act to dilute the product Di-Cal, or contaminate and/or dilute other phosphate materials (such as struvite), thus reducing their phosphorus content and makes separation of the solids difficult (or impossible) due to the gelatinous nature inherent in silica gel.

The processes by which Di-Calcium Phosphate is made by this invention is from the recycle of phosphorus rich solids from a later stage neutralization and separation stage into the clarified liquid stream from an initial clarification and neutralization stage in order to precipitate the product, where a sufficient amount of solids are added to this clarified liquid stream to effect the pH-dependent precipitation of a phosphate product. Or, in the alternative process, an intermediate pH-dependent precipitation of a phosphate product is achieved through the addition of a neutralizing agent. The present invention also covers a process to make struvite by precipitation in the presence of sufficient ammonia and magnesium to form ammonium magnesium phosphate (NH₄)MgPO₄.6H₂O and may be achieved through the addition of other ammonia and magnesium containing reagents. Likewise, the present invention can produce potassium magnesium phosphate in the product generation stage. Both struvite and potassium magnesium phosphate can be made without the dilution of the feed pond water.

The recycled clarified water or dilution waters from the product generation stage and/or the final stage are used to dilute the incoming pond water to significantly enhance yield and to eliminate the deleterious impact of silica on the product quality and separability. As noted previously, the product yield is predicated on the difference in the phosphorus concentration of the clarified water from the first neutralization stage to that of the phosphorus concentration of the resultant water from the product generation stage, with the additional yield gain noted above via dilution of the initial pond water. The acidity or pHs of the first stage and the product generation stage are thus manipulated to achieve the maximum difference in phosphorus concentrations. Furthermore, if feed-grade Di-Calcium phosphate is desired, the pH set point in the first neutralization stage is further optimized to achieve the required fluoride reduction. This allows maximized recovery of phosphate values precipitated as Di-Calcium Phosphate, at various qualities, or as other phosphate-based products, (such as struvite or potassium magnesium phosphate).

The present invention also results in processes with increased water recovery when compared to the traditional double-liming process. The increased water recovery facilitates the industry goal of maximizing the volume of treated water discharged into the environment, thus further reducing the costs associated with impounding large quantities of waste, and pond water.

Since the processes taught herein employ recursive methodologies for the re-use of key ingredients, for example, lime re-use in a more efficient manner via the recycling of products from later reaction stages back into earlier stages to accomplish P recovery, systems employing the methodologies taught herein will decrease the quantities of these ingredients used, thus providing a significant economic advantage to the user. Furthermore, reuse by recycling reduces the quantities of sludge that must be impounded. In addition, the formation and separation of Di-Calcium Phosphate as opposed to hydroxy-apatite reduces the lime consumption significantly owing to the lower Ca:P molar ratio of Di-Cal, CaHPO₄, (1:1) versus hydroxy-apatite, Ca₅(PO₄)₃OH, (5:3). Thus, the precipitation of Di-Cal reduces the overall lime demand, and as the Di-Cal is removed from the system, significantly less final stage sludge is generated. In addition, the precipitation of struvite using in part some of the ammonia and magnesium already present in many pond water also decreases the lime demand. However, the production of struvite may require additional sources of ammonia and magnesium, preferably added to the first stage neutralization.

Accordingly, in one embodiment of the present invention the feed pond water to the process is diluted with clarified water from any later process stage (i.e., product generation stage alone, final stage alone; a mix of product and final stage; or from any intermediate stages). The process does not require any solids recycle, but such a recycle from the final stage separation could be used. Likewise, recycling a portion of the slurry formed in the final stage neutralization could be recycled to either the first stage neutralization and/or the product generation stages. Both feed grade Di-Cal and non-feed grade can be produced by the present invention.

One specific embodiment of the invention is directed to a process for the treatment of pond water from phosphoric acid production activities comprising the steps of a) performing a first stage neutralization comprising the steps of i) mixing pond water with recycled clarified water from one or more later process stages to form a first stage admixture having a measurable pH; ii) increasing the pH of the first stage admixture to form a first stage neutralization precipitate; and iii) separating the first stage neutralization precipitate in a first stage separation to obtain a first clarified water, wherein the first clarified water has a phosphorus and fluoride concentration of P1 and F1 and a measurable pH. After the first stage separation there is a product generation stage comprising the steps of i) forming a product generation stage precipitate; and ii) separating the product generation stage precipitate in a product separation stage to obtain a second clarified water having a measurable pH and a solid product, wherein the solid product contains di-calcium phosphate values reclaimed from the first stage admixture. After the product separation there is a final stage neutralization comprising the steps of i) increasing the pH of the second clarified water by adding lime to form a final stage neutralization slurry; and ii) separating the final stage neutralization slurry in a final stage separation to obtain a third clarified water and final stage solids. Preferably the recycled clarified water is selected from the group consisting of a portion of the second clarified water that results from the product separation, a portion of the third clarified water that results from the final stage separation and mixtures thereof.

It is also possible to recycle later stage solids into the product generation stage, where the later stage solids are selected from the group consisting of the final stage neutralization slurry, the final stage solids, and mixtures thereof. In some instances it may be desirable to recycle at least a portion of the final stage neutralization slurry to mix with the pond water and recycled clarified water.

When the production of an animal feed-grade micronutrient or a raw material for other phosphorus-based products is desired the process is operated where the second clarified water has a phosphorus concentration and a fluoride concentration of P2 and F2, respectively, such that P1 minus P2 divided by F1 minus F2 is ≧100. The dilution of the pond water feed with clarified water allows the process to be run without a silica aging step. Additionally, if desired, a portion of the third clarified water is further processed to remove residual ammonia.

In the first stage neutralization it is preferred that the pH is increased through the addition of a reagent selected from the group consisting of CaCO₃, Ca(OH)₂, CaO, NaOH, NaHCO₃, Na₂CO₃, KOH, KHCO₃, K₂CO₃, NH3, anhydrous, NH₄OH, NH₄Cl, (NH₄)₂SO₄, NH₄F, NH₄NO₃, and mixtures thereof. The process can be further enhanced by adding a flocculating agent to the first stage neutralization and/or to the final stage neutralization step.

In another embodiment of the present invention dilution of the pond water is used and the process is run to obtain a second clarified water and solid product from the product separation stage, where the solid product contains ammonium magnesium phosphate or potassium magnesium phosphate precipitated from the pond water. In particular, the addition of ammonia or magnesium compounds to the product generation stage can be used to form a precipitated struvite product. More specifically potassium and/or magnesium can be added to the product generation stage to form potassium magnesium phosphate in the product generation stage precipitate. Preferably, the pH is increased in the first stage neutralization with a reagent selected from the group consisting of MgCO₃, Mg(OH)₂, MgO, NaOH, NaHCO₃, Na₂CO₃, KOH, KHCO₃, K₂CO₃, NH3, anhydrous, NH₄OH, NH₄Cl, (NH₄)₂SO₄, NH₄F, NH₄NO₃, and mixtures thereof. Of course, the production of struvite and potassium magnesium phosphate can be achieved without the recycle of clarified water and such where there is no dilution of the feed pond water. The formation of struvite allows the sale of a valuable slow release fertilizer.

According to the present disclosure, a process for treatment of pond water includes a first neutralization stage, a product generation stage, and a final neutralization stage. The first neutralization stage includes the steps of first diluting the pond water with water from a later stage, then increasing the pH of the pond water to form a first neutralization stage precipitate as a slurry and separating the first neutralization stage precipitate from the aqueous solution to obtain a clarified liquid. The first neutralization stage water has a propensity to precipitate the calcium fluorosilicate and calcium fluoride species slowly as equilibrium is approached, and thus in many cases needs an ageing period for the fluoride moieties to form and settle. The required ageing time can vary from as low as 1-2 hours to up to 3-7 days. The product generation stage includes the steps of mixing the clarified liquid with solids from a final neutralization stage to form a product generation stage precipitate as a slurry and separating the product generation stage precipitate from the aqueous solution to obtain a solid product and a re-clarified liquid. The solids from the final neutralization stage contain lime values, (i.e., calcium and hydroxide alkalinity) trapped therein that are recycled into the process by mixing with the clarified liquid. The solids thus raise the pH of the clarified liquid. Furthermore, given the recursive nature of the process, phosphate values escaping earlier product generation steps are reintroduced into the product generation step, thus facilitating their capture. By recycling the solids, overall lime consumption is reduced in the process as compared to processes relying solely on the addition of lime, or similar compounds, to raise the pH of the pond water.

In the alternative process, the product generation stage is accomplished by precipitation of a phosphate product through the addition of a neutralizing agent.

In the case of struvite formation, additions of the requisite quantities of ammonia and/or magnesium allow the formation of a material rich in ammonia, and phosphorus, two of the primary fertilization nutrients and containing large concentration of magnesium, a secondary nutrient. The solid products contain phosphate values from the pond water. As indicated above, these solid products are valuable products in that they reclaim phosphate values in the pond water that typically are discarded in the, for example, double-liming treatment of pond water. The final neutralization stage includes the steps of adding lime to increase the pH of the re-clarified liquid to form a final neutralization stage precipitate, separating the final neutralization stage precipitate from the aqueous liquid to form the solids from the final neutralization stage and the clarified treated water and directing the clarified treated water (final effluent) to its desired point, typically discharge to the environment. The solids from the final neutralization stage are the solids that may be added to the product generation stage.

In certain embodiments, the pH is increased in the first neutralization stage with a base selected from the group consisting of CaCO₃, Ca(OH)₂, CaO, MgCO_{3,} Mg(OH)_{2,} MgO, NaOH, NaHCO₃, Na₂CO₃, KOH, KHCO₃, K₂CO₃, ammonia and ammonia salts. In an advantageous embodiment, the pH is increased in the first neutralization stage with lime. In a further advantageous embodiment, the step of increasing the pH of the pond water in the first neutralization stage is performed by the addition of a base in a quantity sufficient to result in a pH of about 3.0 to about 5.0.

In certain embodiments the solids from the final neutralization stage are added in sufficient quantity to raise the pH of the clarified water in the product generation stage to the range from about 4.0 to about 7.5. In an advantageous embodiment, the solids from the final neutralization stage are added in sufficient quantity to raise the pH of the clarified water in the product generation stage to about 6.0-7.5. The solid product from the product generation stage is also suitable for use as a phosphate rock substitute by inclusion in phosphoric acid production. In certain embodiments, a quantity of lime is added to the re-clarified liquid to form the final neutralization stage precipitate in a quantity sufficient to result in a pH of about 8.0-12.0. In an advantageous embodiment, a quantity of lime is added to the re-clarified liquid to form the final neutralization stage precipitate in a quantity sufficient to result in a pH of about 8.0-10.0. In still further advantageous embodiments, a quantity of lime is added to the re-clarified liquid to form the final neutralization stage precipitate in a quantity sufficient to result in a pH of about 9.0-12.0. Raising the pH to the range of about 9.0-12.0 is particularly advantageous where ammonia removal is desired. Alternatively, the range of 8.0-10.0 will generally reduce lime consumption when compared to the range of 9.0-12.0.

In accordance with another aspect of the invention, the process for the treatment of pond water includes a first neutralization stage and a product generation stage. The first neutralization stage includes the steps of increasing the pH of the pond water to form a first neutralization stage precipitate and separating the first neutralization stage precipitate from the aqueous solution to obtain a clarified liquid. The product generation stage includes the steps of mixing the clarified liquid with lime to create a product generation stage precipitate, separating the product generation stage precipitate from the aqueous solution to obtain a solid product and a re-clarified liquid and directing the re-clarified water for further treatment, use or disposal. Lime is added in the product generation stage in a quantity sufficient to raise the pH from about 4.0 to 7.5. In an advantageous embodiment, lime is added in sufficient quantity to raise the pH of the clarified water in the product generation stage to about 6.0-7.5. In certain embodiments, the process further includes the steps of adding lime to increase the pH of the re-clarified liquid to form a final neutralization stage precipitate, separating the final neutralization stage precipitate from the aqueous liquid, to form the solids from the final neutralization stage and the clarified treated water and directing the clarified treated water for further use or disposal.

In accordance with another aspect of the invention, the process for the treatment of pond water includes a first neutralization stage and a product generation stage. The first neutralization stage includes the steps of increasing the pH of the pond water using a magnesium base to form a first stage precipitate and separating this first stage precipitate from the aqueous solution to obtain a clarified liquid. The product generation stage includes the steps of mixing the clarified liquid with ammonia, ammonium hydroxide, or an ammonium salt to create a product generation stage precipitate, separating the product generation stage precipitate from the aqueous solution to obtain a solid product and a re-clarified liquid and directing the re-clarified water for further treatment, use or disposal. Ammonia is added in the product generation stage in a quantity sufficient to raise the pH to the range of about 8.0-10. In certain embodiments, the process further includes the steps of adding lime to increase the pH of the re-clarified liquid to form a final neutralization stage precipitate, separating the final neutralization stage precipitate from the aqueous liquid, to form the solids from the final neutralization stage and the clarified treated water and directing the clarified treated water for further use or disposal. Alternatively, ammonia can be added in the first stage neutralization, followed by magnesium in the product generation step, provided the appropriate stoichiometry or reagent excess is maintained to precipitate the struvite, etc.

### BRIEF DESCRIPTION OF THE FIGURES

The descriptions of the drawings provided below should be reviewed along with the accompanying process schematics. For a more complete understanding, refer to the detailed description following this section. The process schematics include the following:

FIG. 1 illustrates the double liming process, as currently known in the art.

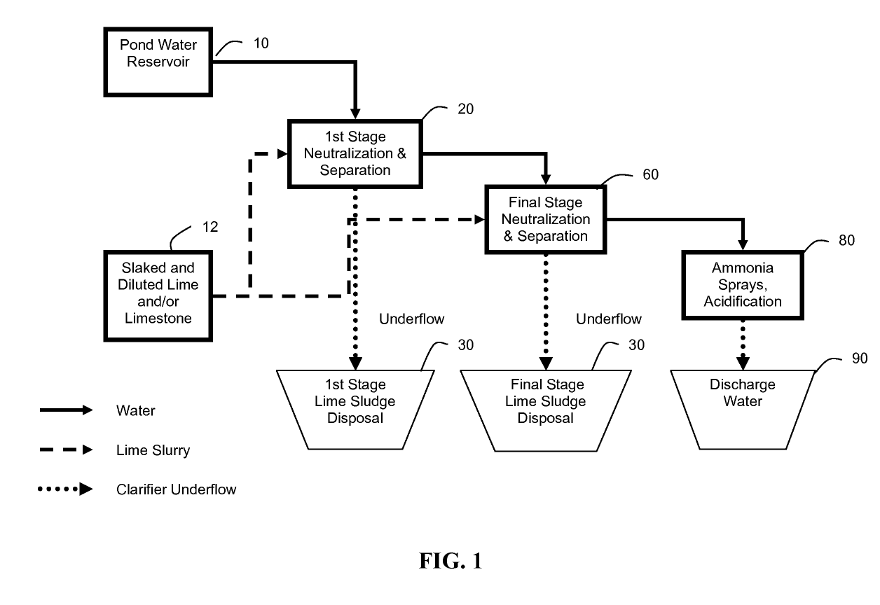

FIG. 2 is a more detailed illustration of the double liming process, as currently known in the art.

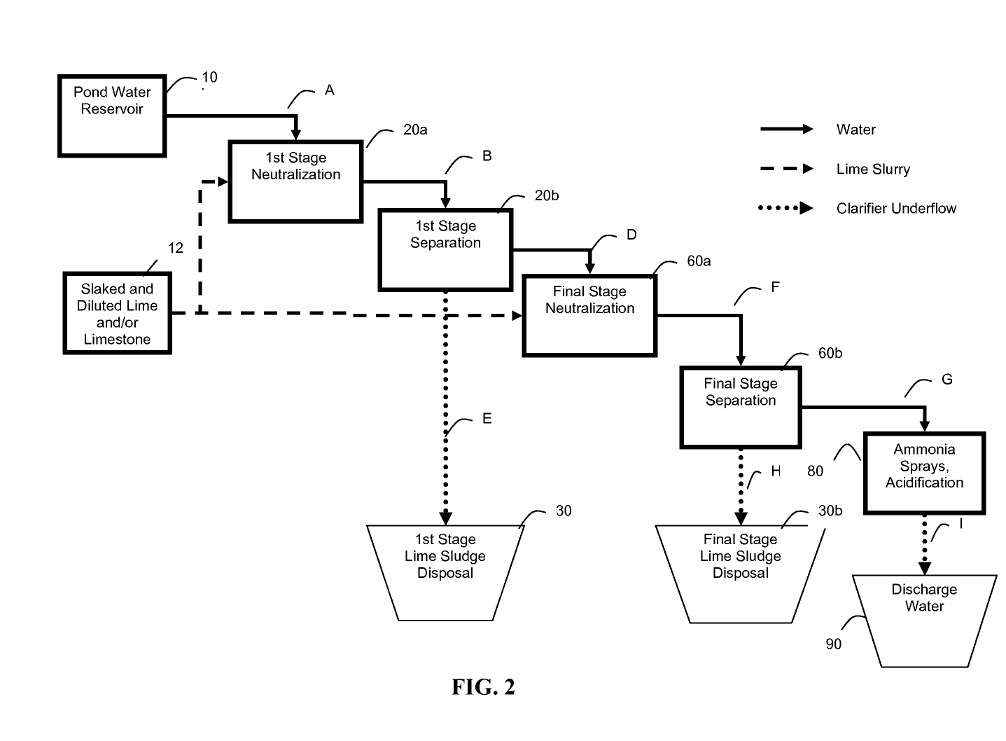

FIG. 3 is a flowchart illustrating an embodiment of the process invention for treating pond water for increased water and phosphorus recovery. FIG. 3 illustrates the scenario where the initial pond water is diluted with either the clarified water from the product generation stage and/or the clarified water from the final stage, and then neutralized in a first stage and where a portion of the underflow stream containing the solids from the final stage separation and/or slurry from the final stage neutralization can be recycled back into the product generation step, thus facilitating reuse of lime and additional recovery of residual phosphate not previously captured. The embodiment depicted in FIG. 3 generates a phosphate product suitable for use as an animal feed micronutrient, and the like.

FIG. 4 is a flowchart depicting an alternative embodiment of the process from that depicted in FIG. 3. The process depicted in FIG. 4 illustrates the scenario where the initial pond water is diluted with either the clarified water from the product generation stage and/or the clarified water from the final stage and then neutralized in a first stage neutralization. The product generation and separation step following the first stage neutralization and separation, is where lime is used to precipitate the product. The process depicted in FIG. 4 does not recycle the solids or the slurry from the final stage neutralization and separation steps to the product generation stage, but instead passes the solids out for disposal.

FIG. 5 is a flowchart depicting an alternative embodiment of the process for the production of struvite. The process depicted in FIG. 5 illustrates the scenario where the initial pond water is diluted with either the clarified water from the product generation stage and/or the clarified water from the final stage, then neutralized in a first stage using a magnesium base or salt. The product generation and separation step following the first stage neutralization and separation is where additional magnesium-based reagents, and/or ammonia are added to effect the precipitation of struvite. Ammonia may also be added at the beginning of the process as well, as it is not removed in the first stage. The subsequent steps of neutralization to generate the final stage waters and the dilution waters required are comparable to the process used to make Di-Cal.

### DETAILED DESCRIPTION

The present invention is directed to a process for treating acidic wastewater (i.e., pond water) from facilities using the wet process for phosphoric acid production. Processes in accordance with embodiments of the invention generate marketable phosphate-based products by reclaiming phosphate values contained in the pond water. Following a first stage neutralization and separation of precipitates in an aqueous matrix (sludge), the resulting clarified liquid can be mixed with the precipitates from the final stage neutralization and separation. It is found that a precipitate product will form from this step (the product generation step). Importantly, this precipitate is found to be high in phosphate content and of suitable characteristics for use in phosphoric acid production, and/or as a feedstock for the production of other products. This step also serves to reduce the phosphate content in the pond water, thus facilitating its discharge to the environment or reuse in the plant. Additionally, processes in accordance with embodiments of the invention reduce the consumption of lime or other neutralizing bases compared to the traditional double-liming process. By optionally recycling all or part of the sludge from the final stage neutralization and separation into the product generation step, the pH of the clarified stream from the first neutralization and separation step is increased, thus necessitating a lower input of lime or other neutralizing base to achieve the desired pH set point. The recycling of sludge from the final stage has the added value of reclaiming phosphate values that have escaped the product generation step and can consequently be viewed as a recursive input of sludge.

Processes according to the present invention can be tailored to meet a variety of objectives based upon the inputs, the limitations of a given facility and the desired outputs, including the composition and properties of that output. For instance, if it is not practical to recycle the final stage sludge to the product generation step, the clarified first neutralization stage water can be neutralized to a pH of about 6 to 7, instead of recycling the final stage sludge.

It is an object of this invention to recover phosphate values from pond water, maximize the amount of treated water that is amendable to environmental discharge, and minimize alkaline reagent (e.g., lime) requirements. The phosphate recovered in the product generation step can be used as a feedstock in phosphoric acid manufacture and/or as a source of high quality phosphate for the production of slow release fertilizers (e.g., struvite) and other phosphate containing materials. The Di-Calcium Phosphate produced by the process typically contains about 18% by weight phosphorus (expressed as P), but will only meet animal feed-grade requirements if the P to F ratio is ≧100:1).

Owing to the greater settling and compaction characteristics produced by the processes of this invention, as compared to those produced by the typical double-liming process, over 75% (by volume) of the total incoming pond water can be discharged as opposed to 60-70% by the conventional double liming process. Also since the final stage sludge solids are used in generating the product, there is a very significant reduction in the sludge impoundment area needed as is the case with the conventional double liming method. In addition, because the final neutralization stage solids are recycled, more of the un-reacted lime is used, which reduces overall lime consumption, and thus lowers the expenditure on lime. The invention is described below in examples that are intended to further describe the invention without limitation to its scope. In the case of both Di-Calcium Phosphate and struvite, the materials have large markets and have recently sold in the $400 to $500 per ton range.

The phrases “first neutralization stage” and “final neutralization stage” used herein are meant to be broadly construed. In the first neutralization stage, the pH of the pond water is increased, thus yielding a more neutral aqueous solution (i.e., closer to pH 7). The pH is similarly increased in the final neutralization stage. However, depending upon how much the pH is increased the solution may or may not be more neutral in the literal sense (i.e., it may be made significantly more alkaline). Thus, reference to the stage as a final neutralization stage is not meant to indicate the solution is necessarily more neutral. Instead, the term is applied as a label for the stage to distinguish the stage from other stages in the process.

Additionally, the phrases “first liming stage” and “final liming stage” are used interchangeably with the terms “first neutralization stage” and “final neutralization stage”, respectively, and are meant to be broadly construed. While lime and/or limestone are often used to increase the pH in the first liming stage, reference to the stage as the “first liming stage” is not meant to indicate that lime or limestone-based reagents must be used to increase the pH of the solution, unless otherwise specifically indicated. Instead, the term “first liming stage” is applied to the stage to distinguish it from other stages in the process, i.e., as a non-literal, named step of the process.

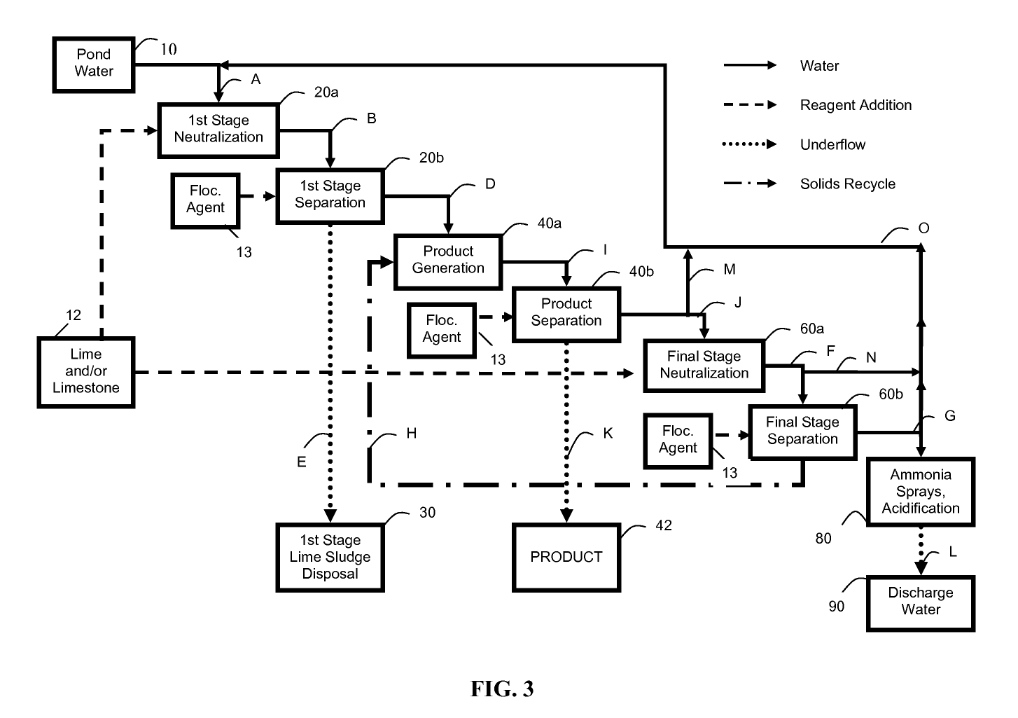

FIG. 3 is one embodiment of the process according to the invention for treating plant pond water for increased water and phosphate recovery, compared to the double-liming process. The initial pond water to be treated, stream 10, is diluted by the clarified water from the product generation stage, stream M, and/or with water from the final stage, stream O. The amount of dilution required is dependent on the concentration of phosphorus in the pond water. In general, the more concentrated the pond water is with respect to phosphorus, the higher the dilution can be to affect maximum recovery, (see description and example calculation provided earlier in this document). Preferably, the amount of clarified water (as a total from all sources) can be from about 5% to about 250% of the amount of pond water feed, most preferably is a 1:1 dilution.

Some of the final stage solids can also be recycled to the front of the process to recover P provided that the first neutralizing stage pH set point and the initial pond water dilution ratio are such that is the phosphorus is inadvertently lost in the first stage underflow, stream E. A base 12 (or mixture of bases) is added to the diluted pond water, stream A for the first stage neutralization 20a. The base 12 can be a calcium-based (liming) compound (e.g. CaCO₃, Ca(OH)₂ or CaO) and/or a sodium-based compound (e.g., NaOH, NaHCO₃, Na₂CO₃), and/or a potassium-based compound (e.g. KOH, KHCO₃, K₂CO₃), and/or an ammonia-based compound (e.g., anhydrous ammonia, NH₄OH) with/without supplemental ammonium salts (e.g., NH₄Cl, (NH₄)₂SO4, NH₄F, NH₄NO₃) etc., that will react with the pond water constituents, allowing the soluble fluoride and some of the phosphate species present to precipitate until an acceptable phosphorus and fluoride concentration in the remaining liquid is achieved. The addition of a sodium and/or potassium salt can be advantageous due to the preferential precipitation of sodium and potassium fluorosilicates, followed by the further precipitation of fluorides and fluorosilicates with additional lime or other base. The resultant reaction product is clarified in the first stage separation 20b and the separated solids, stream E, is directed to the first stage lime sludge disposal 30.

The clarified water, stream D, from the first stage separation 20b is now reacted with the solids, stream H, produced from the final stage neutralization 60a. The step is called product generation, 40a. The resultant solids are separated from the water by settling and or filtration and further processed by conventional means to give a dried or semi-dry product 42. This material, containing high levels of phosphate and minimal levels of fluoride and metals, is suitable for use as an animal feed micro nutrient supplement or as a feedstock in other applications where a phosphate-based material of high purity is desired. In cases where, for example, a product containing higher levels of fluoride are acceptable (relative to feed-grade Di-Cal requirements), a higher yield of non-feed grade Di-Cal can also be produced. Alternately, the product can be processed further to produce a technical-grade phosphoric acid, or some other product. Irrespective of its final utility, the product is a marketable and salable product as opposed to a voluminous waste that must be impounded at significant cost.

The supernatant, stream J, produced in the product separation step 40b is directed to the final stage neutralization 60a. In addition, a stream of dilution water, stream M, can be taken from stream J, and used to dilute the initial pond water, stream 10. Lime 12 is then added to the clarified water stream J, which has an initial pH of about 6-7.5, to raise the pH to the appropriate level to precipitate the majority of the residual phosphate. The increase in pH results in the precipitation of solids, which is separated in the final stage separation 60b, thus producing the solids stream H, that is recycled to product generation, 40a along with the first stage clarified water, stream D. Any un-reacted lime and phosphorus in the final neutralization stage solids, stream H ate then reacted, thus producing a pure calcium phosphate product, while reducing the overall lime consumption. In the conventional double liming processes, the final neutralization stage solids are generally discarded, and not recycled. Consequently, the value of the un-reacted lime in those solids is lost.

The pH set points in the first stage neutralization 20a and the product generation stage 40a are adjusted to maximize the product yield that also possesses acceptable chemical specifications for use or sale in the target market(s) in which it will be marketed and sold. In general, the difference in the phosphorus concentration of the clarified water streams D and J, compared to the initial pond water and taking into account dilution (as described above) will reveal the P yield obtained. The set-point pH in the first stage neutralization, 20a and product generation stage, 40a are thus adjusted to achieve the desired respective phosphorus concentrations, so as to maximize the recovery of phosphate values while meeting the fluoride specification (as applicable).

Following the separation and recycle of the solids, the resultant clarified final stage separation water, stream G, can be further treated by the Ammonia Sprays, Acidification, (box 80) in preparation for discharge, stream L. However, from this stream G, a stream of dilution water, stream O, optionally with an amount of solids from the final stage neutralization, stream N, can be used to dilute the initial pond water, 10. The clarified final stage separation water, stream G, can be treated to reduce the pH to between 6.5-8 such that the water can meet discharge quality requirements. In the treatment of phosphoric acid process pond waters containing high levels of soluble ammonia, the pH is further elevated above 9, and preferably to between 10-12, such that residual ammonia can be removed by aerial spraying and air stripping. Even without the addition of a spray system, operation at pH>9 will result in the removal of ammonia through volatilization if a large surface area is available for such activity. The treated water, now having a significantly reduced ammonia concentration, can be further treated to reduce the pH to between 6-9 such that the water can meet discharge quality requirements.

Hydrated lime is generally an advantageous material for use in the process, preferably in the final stage neutralization 60a. The reacted slurry from the first stage neutralization, stream B, can be mixed with a flocculating agent 13. The resulting flocculated mixture is introduced into a clarification device for the first stage separation 20b where the liquid and solids phases separate. The device typically used in the industry is a conventional clarifier. The solid phase, stream E, is withdrawn and deposited into a first stage lime sludge disposal (box 30) for dewatering and consolidation. The clarified first stage separation water, stream D, is then mixed with the underflow, stream H, from the final stage separation 60b. The recycled solids, stream H, react with the first separation clarified water, stream D, and precipitate a product, stream K, containing high levels of phosphate, but low levels fluoride, silicates and metals. Following the separation of the resultant solid by filtration, settling (or other means), the product can be dried (if needed) and/or further processed to produce a material suitable for marketing and sale in the desired market(s).

There is usually a significant content of silica in the pond waters, stream 10, to be treated the processes of this invention. Some of the silica and fluorosilicate that is not precipitated in the first stage neutralization 20a will hydrolyze and form gels and emulsions, making separation of the product difficult. Silica can also adversely affect the separation of the material to be recycled from the final stage separation, 60b. The dilution of the pond water 10 with final stage separation clarified water, stream G and/or product separation clarified waters, stream M, both of which have been depleted in silica content, prevent the gelling of silica, and thus precludes the need to separate it in a separate step as previously documented. This simplification of the process, made possible through the use of pond water dilution is significant and provides an improved product quality and separability, due to the reduced contamination by silica.

The product separation clarified water, stream J, is now directed to the final stage neutralization 60a where it is mixed with an additional quantity of neutralizing base material, such as hydrated lime slurry, in a suitable vessel with the purpose of raising the pH to approximately 9-10. The final stage neutralization reacted slurry, stream F, can be optionally mixed with a flocculating agent and introduced into the final stage separation device (box 60b) where the liquid and solid phases are separated. The underflow, stream H, containing the residual phosphate values is recycled to the product generation step 40a and mixed with the first stage separation clarified water, stream D, to generate the product previously described. The final stage separation clarified water, stream G, can then be discharged at step 90, following adjustment of the pH, step 80, with an acid to achieve near neutrality (generally pH 6-8). However, if the liquid phase, stream G, from the final stage separation requires processing to remove ammonia, step 80, additional base is added in the final stage neutralization 60a to raise the pH from the typical range of 9-10, to the higher range of 10-12, and following spray evaporation to achieve an acceptable ammonia concentration, step 80, the pH is adjusted with an acid, to achieve the near neutrality required for discharge.

Lime has a low solubility in water and is virtually insoluble at pH>10. Consequently, the high pH final stage separation slurry, stream H, can contain large amounts of un-reacted lime. In addition, this stream H is very voluminous because of the nature and phases of the precipitated solids contained with. It can contain between 20-40% by volume of the total water in the final stage separation 60b because the solids in this sludge do not compact well on standing and only average about 7% solids by weight. Therefore, by recycling this final stage separation sludge, stream H, and blending with the more acidic first stage separation clarified water, stream D, in the product generation step 40a, and with good agitation, the lime reacts with most of the voluminous solids to produce mono and di-calcium phosphate. The mono and di-calcium phosphate slurry, or product stream K, compacts to almost 30% solids upon clarification. The solids are removed as a 30% by weight solids slurry, rather than a 7% solids slurry. This increases the amount of clarified water that may be ultimately discharged by the process in stream L when compared with the conventional double-liming process, and the recovery of un-reacted lime is significantly improved.

A process according to the present invention thus generates additional phosphate-based product via reclaiming the phosphate values not captured in the source wet phosphate production process. The product is produced in step 40a, which is intermediate to first and final stage neutralizations. By employing this additional step, product is generated from the downstream final stage separation solids, stream H. The phosphate-based product is then separated by settling and or filtration (box 40b) and may be further processed, as required, using conventional unit operations to yield a drier final product. However, if a dry product is not necessary, the product may be used in its native slurry form whereby, for example, it is incorporated into a phosphoric acid plant. This material is a valuable, marketable and salable product as opposed to the voluminous waste that must impounded from the conventional double-liming process. In addition, the material can be further processed by acidification and by separation of the insoluble calcium salt, to liberate a purified phosphoric acid.

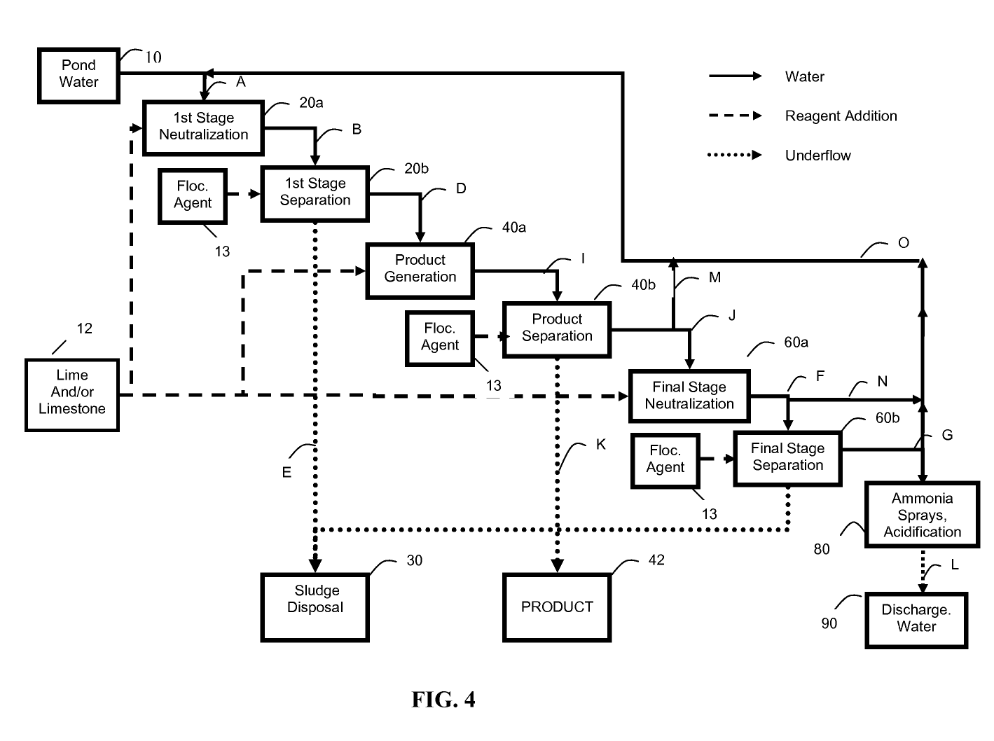

The clarified water produced in the product separation step 40b, is then limed in the final stage neutralization 60a to produce the material that is recycled to form the phosphate product in stream H. If lime is used to achieve the intermediate stage pH in the product generation stage 40a (see FIG. 4), rather than the recycled sludge, stream H from the final stage separation (see FIG. 3), then the resultant solids from the final stage separation are discarded due to their low grade (low phosphate content) or in rare cases, may be conducive to reprocessing in the phosphoric acid facility. Under this scenario, however, lime consumption is greater, but the process still yields a high grade phosphate-based product in the product generation step, 40a. The clarified water from the final stage separation can then be treated to reduce ammonia content and adjust the pH to with the range acceptable for discharge (generally pH 6-9).

Another advantage of the process is the reduced conductivity in the final effluent, stream L from the process as compared to the double-liming process. This is accomplished because the neutralization of pond water in the first stage neutralization 20a at a typical pH of 4 rather than the conventional double-liming pH of 5.5, results in a reduced sodium concentration in the final treated water, stream Land thus reduction in final conductivity. From a chemical perspective, the hydrolysis of the fluorosilicate ion occurs at a pH of just above 4. Thus, sodium that would otherwise precipitate as sodium fluorosilicate, remains in solution and contributes to the final conductivity in the double-liming process.

Turning now to FIG. 4, a further modification of the process can be accomplished by using lime in the product generation step 40a to raise the pH of first stage separation clarified water stream D to about pH 5.0-7.5 and thus form the product K rather than using the solids from the final stage separation 60b, (stream H, as shown in FIG. 3). The pond water, stream 10, is diluted by the clarified waters from the product separation stage, stream M, and/or the final stage separation, stream O. The amount of dilution required is dependent on the concentration of phosphorus in the pond water. In general, the more concentrated the pond water is with respect to phosphate, the higher the dilution can be to affect maximum recovery, (see description and example calculation provided earlier in this document). One consideration in performing the process as embodied in FIG. 4 is that the total phosphate values still present in the final stage separation underflow slurry, (stream H, as depicted in FIG. 3) will be lost, thus causing a reduction in product yield. There will still be a reduction in neutralization costs necessary to treat the water versus double-liming however. As described previously, the lime savings is a result of the reduced Ca:P molar ratio of the product Di-Cal (1:1 in the product generation stage 40a), versus hydroxyapatite (5:3 in final stage neutralization, 60a). A lower Ca:P translates simply to less lime needed to remove the P values from the waters.

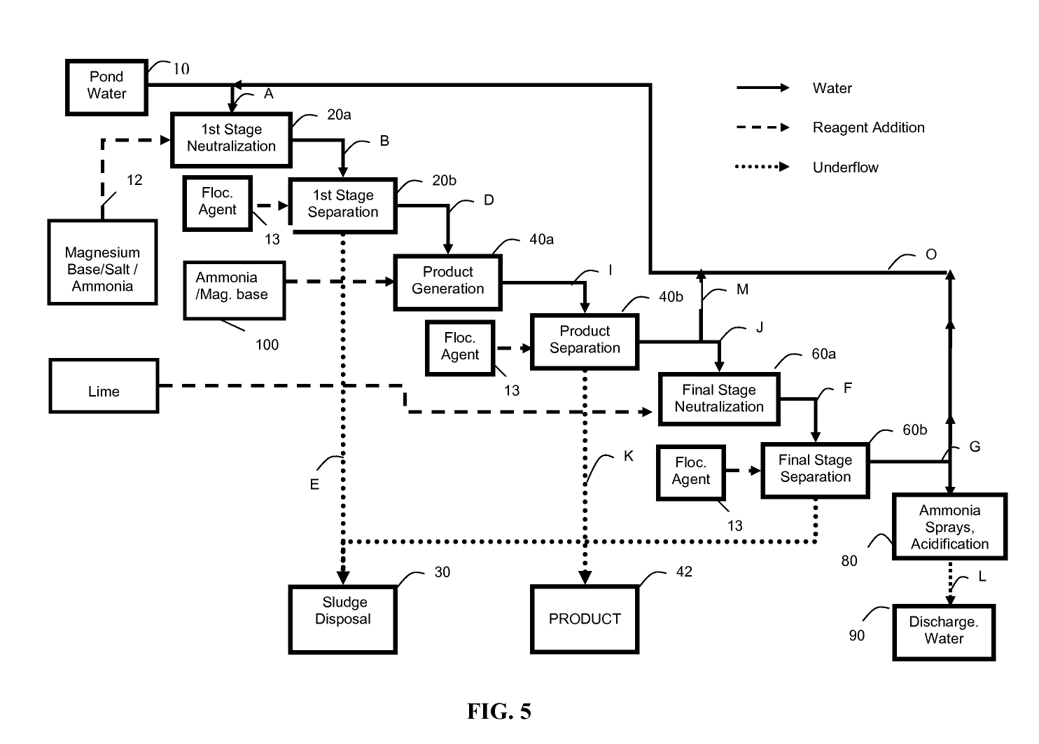

Turning to FIG. 5 a further embodiment of the process is shown schematically for the treating of pond water to maximize water and phosphate values recovery. The pond water, stream 10, is diluted with product separation clarified water, stream M and/or final stage separation clarified water, stream O. The amount of dilution required is dependent on the concentration of phosphate in the pond water. In general, the more concentrated the pond water is with respect to phosphate, the higher the dilution can be to affect maximum recovery, (see description and example calculation provided earlier in this document). In addition, the dilution water has the same beneficial effects to mitigate silica gelling, as described above in the prior embodiments of the process. A base 12 or mixture of bases is added to the now diluted pond water, stream A for the first stage neutralization 20a. The base 12 can magnesium-based (e.g. MgCO₃, Mg(OH)₂ or MgO), sodium-based (e.g., NaOH, NaHCO₃, Na₂CO₃), potassium-based (e.g. KOH, KHCO₃, K₂CO₃), ammonia-based (e.g., anhydrous ammonia, or NH₄OH), or a combination of any of these, combined optionally with ammonium salts (e.g., NH₄Cl, (NH4)₂SO₄, NH4F, NH₄NO₃) etc., that will react with the pond water constituents, causing some of the soluble fluoride, and silica present to precipitate. The addition of a sodium and/or potassium-based salt can be advantageous due to the preferential precipitation of sodium and potassium fluorosilicates, followed by the further precipitation of fluorides and fluorosilicates with additional magnesium compounds. The resultant reaction product is clarified in the first stage separation 20b and the separated solids, stream E, disposed of in the sludge disposal area 30.

Following the first stage neutralization step 20a wherein a magnesium compound is added, the product generation step 40a is accomplished with the addition of an ammonia-based reagent, typically ammonium hydroxide and/or an ammonium salt, with additional magnesium compound to the first stage separation clarified water, stream D, in the product generation step 40a, thus leading to the product 42, after product separation, 40b.

The product 42, magnesium ammonium phosphate, (NH₄)MgPO₄.6H₂O, is formed by the reaction of magnesium compounds with phosphate values in the pond water, supplemented with ammonium-based reagents in cases where the pond water does not contain sufficient amounts of ammonium ions. Thus, an alternate product is generated, and the recycle of clarified water from the product separation, 40b or final stage separation, stream G serves as dilution and maximizes the recovery of phosphorus values while mitigating or eliminating the deleterious effects of silica gelling as previously explained in the embodiments described above. Thus, the processes according to the present invention is characterized by an enhanced recovery of treated water, reduced sludge impoundment and reduced lime consumption when compared to conventional double liming processes.

Alternatively, an ammonium compound can be use in the first stage, 20a, and a magnesium compound used in the product generation stage, 40a.

The disclosure of all publications cited above is expressly incorporated herein by reference, each in its entirety, to the same extent as if each were incorporated by reference individually.

It will be seen that the advantages set forth above, and those made apparent from the foregoing description, are efficiently attained and since certain changes may be made in the above construction without departing from the scope of the invention, it is intended that all matters contained in the foregoing description or shown in the accompanying drawings shall be interpreted as illustrative and not in a limiting sense.

It is also to be understood that the following claims are intended to cover all of the generic and specific features of the invention herein described, and all statements of the scope of the invention which, as a matter of language, might be said to fall there between. Now the invention has been described.

### EXAMPLE 1

The following example demonstrates the increase in P₂O₅ yield and reduced silica precipitation as a result of diluting the pond water with water from a final stage of double-liming. A sample of raw pond water containing about 7,500 ppm phosphorus (P) was divided into four samples. To sample numbers 2, 3, and 4, water containing about 800 ppm P, also containing the suspended solids from a final stage of double liming, was added to increase the feed pond water by a volume increase of 33, 50 and 100 wt % respectively. All four waters were treated with lime and agitated to a pH of about 4.2. The water and solids mixtures were allowed to clarify overnight, and were then decanted.

The dilution water containing about 800 ppm of P would be typical of water generated at a pH of about 6-7. The slurry generated at pH 8-11 would be typical of that made by neutralizing the pH 6.5 water, thus simulating the recycle of the product generation water or final stage neutralization slurry depicted in FIGS. 3 and 4.

Analysis of the P content of the solids and titrated water at pH 4.2 was made, as was the F content of the water. The four samples that were titrated to pH 4.2 were then titrated with lime to about pH 6.5 to produce a Di-Calcium Phosphate product. The samples were allowed to sit overnight to separate the Di-Cal product from the pH 6.5 water (clarified water).

Clarified water from Sample 1, the undiluted pond water sample, showed evidence of silica hydrolysis, i.e. gelling. Analysis of the P content of the solids and in the water at pH 6.5, as well as the F content of the water only, were then made. After correcting for the clarified water weight, the P content for each sample was calculated on a 1000 gallons of raw pond water basis. The results are shown in the table below:

### Pounds of P in Product Expected Per 1000 Gallons Raw Pond Water

No Dilution: 134 lbs.
1:0.33 Dilution: 160 lbs.
1:0.50 Dilution: 168 lbs.
1:1 Dilution: 196 lbs.

As the results above indicate, a 33% water dilution results in a 19% increase in P production from the pH 4.2 water, a 50% water dilution results in a 27% increase in P production from the pH 4.2 water, and a 100% water dilution results in a 52% increase in P production from the pH 4.2 water. Each of the above products had a P/F ratio in excess of 100:1.

The results showed that while the concentration of P in the clarified solutions was slightly lowered, this was completely off-set by the increased volume of water. Thus, the amount of P in solution available to make product in the product stage was thereby increased. Further dilution (above 1:1) would eventually result in a reduction of P recovery, and also would increase the hydraulic load on the processing facilities due to the recirculation of even more latter stage waters. The majority of the increase in P was not due to the additional 800 ppm P added by the dilution water, but by keeping a larger amount of P in solution from the raw pond water, thus reducing the losses of P in the first stage neutralization at pH 4.2. Because of the lowered concentration of silica in solution, due to the dilution, it was noted that silica precipitation was retarded, or eliminated at 1:1 dilution. The silica came out of the non-diluted sample at a 6.4 pH, but less silica was observed as the dilution percentage was increased. No evidence of silica gelling was seen in the 1:1 dilution test.

### EXAMPLE 2

A continuous pilot plant was constructed consisting of three stages:

First Neutralization and Separation Stage (Stage 1)—This stage serves to precipitate most of the fluoride in the raw pond water. The pH is controlled to minimize the loss P in this stage, and to achieve an acceptable F reduction such that the product generated in Stage 2 will meet Feed Grade specifications, P:F>100:1, and.

A Product generation and Separation Stage (Stage 2)—This is where the phosphorus is recovered as a relatively pure feed grade Di-Calcium Phosphate. The pH is controlled to maximize the P precipitated in this stage, without forming gelatinous hydroxy-apatite, and

A Final Neutralization and Separation Stage (Stage 3)—This is where residual phosphorus, fluoride and heavy metals in the Stage 2 clarifier effluent are precipitated prior to final effluent polishing to meet ammonia and conductivity requirements.

Each stage comprised a 17 liter agitated reactor which overflowed to a clarifier of similar volume. Peristaltic pumps were used to meter the lime slurries, to meter the raw pond water feed, to transfer and meter various water streams to and from each of the stages, and to remove slurries from the clarifier underflows.

A first run was conducted without dilution of the raw pond water. The system operated with the following flow rates and concentrations of P and F
7509 ppm P
4700 ppm F

No Dilution Water from Product Generation or Final Stage Clarifier

Stage One Input
100 ml/minute Raw Pond Water
0 ml/minute of Dilution Water
Lime 18 ml/min
pH 4.25

Stage One Output
108 ml/min to Product Generation Stage
Blow down 20 ml/min
Liquor 3037 ppm P
Liquor 43 ppm F

Product Generation Stage Output
Liquor
   127 ml/min
   pH 6.53
   1002 ppm P
   22 ppm F
   Calc Delta P YLD . . . 96 #1000 Gallons
Di-Cal Product
   18.08% P
   0.177% F
   102:1 P:F ratio
   Blow down 22 ml/min
   Weight of Di-Cal . . . 91 #/1000 Gallons
   14% solids blow down,
   4 min 30 seconds to filter about 148 gms from 1 liter of underflow slurry
   filtered to 33% solids cake, Stage Three Input
127 ml/minute Stage 2 Water
Lime 3.8 ml/min

Stage Three output
pH 10.97
Blow down 29 ml/min
Liquor 143 ppm P
Liquor 12 ppm F

Poor filtration, low product yield from the second stage, low analysis etc. This phase indicated that in the absence of dilution of the feed water, that product separation was hindered and that the quantity and quality of the product obtained was reduced.

A second run was performed with a 1:1 dilution of the raw pond water with a pH 11 Stage 3 effluent. The system operated with the following flow rates and concentrations.

Raw Pond Water
50 ml/minute
7509 ppm P
4700 ppm F

Dilution Water from Final Stage Product Clarifier
50 ml/minute
16 ppm P
5 ppm F

Stage One Input
50 ml/minute Raw Pond Water
50 ml/minute of Dilution Water
Lime 5.6 ml/min (6.04 2 days)
pH 4.29 (4.19 2 days)

Stage One Output
135 ml/min to Product Generation Stage
Blow down 20 ml/min (25 2 days)
Liquor 2449 ppm P
Liquor 40 ppm F

Product Generation Stage Reactor

Input
135 ml/min to Product Generation Stage
Lime 2.9 ml/min
pH 6.44

Output
Liquor
   127 ml/min
   600 ppm P
   21 ppm F
   Calc Delta P YLD . . . 157 #1000 Gallons
Di-Cal
   Blow down 22 ml/min
   18.21% P
   0.161% F
   113:1 P:F ratio
   Weight of Di-Cal . . . 152 #/1000 Gallons New feed
   13% solids blow down,
   2 min 23 seconds to filter about 133 gms from 1 liter of underflow slurry
   filtered to 34% solids cake

Stage Three Input
165 ml/minute Stage 2 Water
Lime 2.6 ml/min
pH 10.5

Stage Three Output
Blow down 22 ml/min
Liquor 16 ppm P
Liquor 5 ppm F

This second run with a 1:1 dilution of the pond water increased the overall recovery of P in the process. In the case of effluent recycle, recycle shifts the amount of P recovered to Stage 2 where it has been shown that overall an overall P recovery up to 65% is possible, e.g. 152 # DiCal/1000 Gallons with 1:1 dilution, versus 91 # of DiCal/1000 Gallons without dilution. Where no such restriction exists, however, the recycling of effluent from Stage 3 greatly increases the process P recovery.

1. A process for the treatment of pond water from phosphoric acid production activities comprising the steps of:
a) performing a first stage neutralization comprising the steps of:
i) mixing pond water with recycled clarified water from one or more later process stages to form a first stage admixture having a measurable pH;
ii) increasing the pH of the first stage admixture to form a first stage neutralization precipitate; and
iii) separating the first stage neutralization precipitate in a first stage separation to obtain a first clarified water, wherein the first clarified water has a phosphorus and fluoride concentration of P1 and F1 and a measurable pH;
b) performing a product generation stage comprising the steps of:
i) forming a product generation stage precipitate; and
ii) separating the product generation stage precipitate in a product separation stage to obtain a second clarified water having a measurable pH and a solid product, wherein the solid product contains di-calcium phosphate values reclaimed from the first stage admixture; and
c) performing a final stage neutralization comprising the steps of:
i) increasing the pH of the second clarified water by adding lime to form a final stage neutralization slurry;
ii) separating the final stage neutralization slurry in a final stage separation to obtain a third clarified water and final stage solids.

2. The process of claim 1 where the recycled clarified water is selected from the group consisting of a portion of the second clarified water, a portion of the third clarified water and mixtures thereof.

3. The process of claim 1 further comprising recycling later stage solids into the product generation stage, where the later stage solids is selected from the group consisting of the final stage neutralization slurry, the final stage solids, and mixtures thereof.

4. The process of claim 2 further comprises recycling at least a portion of the final stage neutralization slurry to mix with the pond water and recycled clarified water

5. The process of claim 1 where the second clarified water has a phosphorus concentration and a fluoride concentration of P2 and F2, respectively, such that P1 minus P2 divided by F1 minus F2 is ≧100 such that the solid product can be used as an animal feed-grade micronutrient or as a raw material for other phosphorus-based products.

6. The process of claim 1 further characterized in that a silica aging step is not used.

7. The process of claim 1 further characterized in that a portion of the third clarified water is further processed to remove residual ammonia.

8. The process according to claim 1 wherein the pH is increased in the first stage neutralization with a reagent selected from the group consisting of CaCO₃, Ca(OH)₂, CaO, NaOH, NaHCO₃, Na₂CO₃, KOH, KHCO₃, K₂CO₃, NH3, anhydrous, NH₄OH, NH₄Cl, (NH₄)₂SO₄, NH₄F, NH₄NO₃, and mixtures thereof.

9. The process according to claim 1 wherein the step of increasing the pH of the pond water admixture in the first stage neutralization is performed by the addition of a base in a quantity sufficient to result in a pH ranging about 3.0-5.0.

10. The process according to claim 1 further comprising the step of adding a flocculating agent to the first stage neutralization.

11. The process according to claim 1 further comprising the step of adding a flocculating agent to the final stage neutralization step.

12. A process for the treatment of pond water from phosphoric acid production activities comprising the steps of:
a) performing a first stage neutralization comprising the steps of:
i) mixing pond water with recycled clarified water from one or more later process stages to form a first stage admixture having a measurable pH;
ii) increasing the pH of the first stage admixture to form a first stage neutralization precipitate; and
iii) separating the first stage neutralization precipitate in a first stage separation to obtain a first clarified water, wherein the first clarified water has a phosphorus and fluoride concentration of P1 and a measurable pH;
b) performing a product generation stage comprising the steps of:
i) forming a product generation stage precipitate; and
ii) separating the product generation stage precipitate in a product separation stage to obtain a second clarified water and solid product, where the solid product contains ammonium magnesium phosphate or potassium magnesium phosphate precipitated from the pond water; and
c) performing a final stage neutralization comprising the steps of:
i) increasing the pH of the second clarified water by adding lime to form a final stage neutralization precipitate;
ii) separating the final stage neutralization precipitate in a final stage separation to obtain a third clarified water and final stage solids.

13. The process of claim 12 further comprising adding ammonia or magnesium compounds to the first stage neutralization.

14. The process according to claim 12 further comprising adding ammonia or magnesium compounds to the product generation stage to form a precipitated struvite product.

15. The process according to claim 12 further comprising adding potassium or magnesium to the product generation stage to form potassium magnesium phosphate in the product generation stage precipitate.

16. The process according to claim 12 further comprising adding potassium and magnesium to the product generation stage to form potassium magnesium phosphate in the product generation stage precipitate.

17. The process of claim 12 further characterized in that a silica aging step is not used.

18. The process of claim 12 further characterized in that a portion of the third clarified water is further processed to remove residual ammonia.

19. The process according to claim 12 wherein the pH is increased in the first stage neutralization with a reagent selected from the group consisting of MgCO₃, Mg(OH)₂, MgO, NaOH, NaHCO₃, Na₂CO₃, KOH, KHCO₃, K₂CO₃, NH3, anhydrous, NH₄OH, NH₄Cl, (NH₄)₂SO₄, NH₄F, NH₄NO₃, and mixtures thereof.

20. A process for the treatment of pond water from phosphoric acid production activities comprising the steps of:
a) performing a first stage neutralization comprising the steps of:
i) providing pond water having a measurable pH;
ii) increasing the pH of the first stage admixture to form a first stage neutralization precipitate; and
iii) separating the first stage neutralization precipitate in a first stage separation to obtain a first clarified water, wherein the first clarified water has a phosphorus and fluoride concentration of P1 and a measurable pH;
b) performing a product generation stage comprising the steps of:
i) forming a product generation stage precipitate; and
ii) separating the product generation stage precipitate in a product separation stage to obtain a second clarified water and solid product, where the solid product contains ammonium magnesium phosphate or potassium magnesium phosphate precipitated from the pond water; and
c) performing a final stage neutralization comprising the steps of:
i) increasing the pH of the second clarified water by adding lime to form a final stage neutralization precipitate;
ii) separating the final stage neutralization precipitate in a final stage separation to obtain a third clarified water and final stage solids.

21. The process of claim 20 further comprising adding ammonia or magnesium compounds to the first stage neutralization.

22. The process according to claim 20 further comprising adding ammonia or magnesium compounds to the product generation stage to form a precipitated struvite product.

23. The process according to claim 20 further comprising adding potassium or magnesium to the product generation stage to form potassium magnesium phosphate in the product generation stage precipitate.

24. The process according to claim 20 further comprising adding potassium and magnesium to the product generation stage to form potassium magnesium phosphate in the product generation stage precipitate.

25. The process of claim 20 further characterized in that a silica aging step is not used.

26. The process of claim 20 further characterized in that a portion of the third clarified water is further processed to remove residual ammonia.

27. The process according to claim 20 wherein the pH is increased in the first stage neutralization with a reagent selected from the group consisting of MgCO₃, Mg(OH)₂, MgO, NaOH, NaHCO₃, Na₂CO₃, KOH, KHCO₃, K₂CO₃, NH3, anhydrous, NH₄OH, NH₄Cl, (NH₄)₂SO₄, NH₄F, NH₄NO₃, and mixtures thereof.
